(19) United States
(12) Patent Application Publication
(10) Pub. No.: US 2006/0109559 A1
(43) Pub. Date: May 25, 2006

(54) Catadioptric multi-mirror systems for projection lithography

(75) Inventors: Russell Hudyma, San Ramon, CA (US); Wilheim Ulrich, Aalen (DE)

Correspondence Address: DARBY & DARBY P.C., P. O. BOX 5257, NEW YORK, NY, 10150-5257, US

(73) Assignee: Carl Zeiss Semiconductor Manufacturing Technologies AG, Oberkochen (DE)

(21) Appl. No.: 10/521,504

(22) PCT Filed: Jul. 17, 2002
(86) PCT No.: PCT/US02/22766

§ 371 Date: Jul. 28, 2005

(51) Int. Cl. G02B 3/00

(52) U.S. Cl. 359/649

(57) ABSTRACT

According to one exemplary embodiment, a photolithographic reduction projection catadioptric objective is provided and includes a first optical group (G1) and a second substantially refractive optical group (G2) more image forward than the first optical group (G1). The second optical group (G2) includes a number of lens elements (E4-E16) and has a negative overall magnifying power for providing image reduction. The first optical group (G1) has a folded geometry for producing a virtual image and the second optical group (G2) receives and reduces the virtual image to form an image with a numerical aperture of at least substantially (0.80).

### TECHNICAL FIELD

The present invention relates to an optical system of a reduction exposure apparatus, such as steppers and microlithography systems and more particularly, relates to catadioptric reduction optical systems suitable for use with ultraviolet light sources and including a sufficiently high numerical aperture to provide improved lithography performance in the ultraviolet wavelength region.

### BACKGROUND

In the manufacture of semiconductor devices, photolithography is often used, especially in view of the circuit patterns of semiconductors being increasingly miniaturized in recent years. Projection optics are used to image a mask or reticle onto a wafer and as circuit patterns have become increasingly smaller, there is an increased demand for higher resolving power in exposure apparatuses that print these patterns. To satisfy this demand, the wavelength of the light source must be made shorter and the NA (numerical aperture) of the optical system (i.e., the projection lens) must be made larger.

Optical systems having a refractive group have achieved satisfactory resolutions operating with illumination sources having wavelengths of 248 or 193 nanometers. As the element or feature size of semiconductor devices becomes smaller, the need for optical projection systems capable of providing enhanced resolution increases. In order to decrease the feature size which the optical projection systems used in photolithography can resolve, shorter wavelengths of electromagnetic radiation must be used to project the image of a reticle or mask onto a photosensitive substrate, such as a semiconductor wafer.

Because very few refractive optical materials are able to transmit significant electromagnetic radiation below a wavelength of 193 nanometers, it is necessary to reduce to a minimum or eliminate refractive elements in optical projection systems operating at wavelengths below 193 nanometers. However, the desire to resolve ever smaller features makes necessary optical projection systems that operate at the extreme ultraviolet wavelengths, below 200 nm; and therefore, as optical lithography extends into shorter wavelengths (e.g., deep ultraviolet (DUV) or vacuum ultraviolet (VUV)), the requirements of the projection system become more difficult to satisfy. For example, at a wavelength of 157 nm, access to 65 nm design rules requires a projection system with a numerical aperture of at least 0.80. As optical lithography is extended to 157 nm, issues relating to resist, sources and more importantly calcium fluoride have caused substantial delays to the development of lithography tools that can perform satisfactorily at such wavelengths. In response to the technical issues relating to the source and the material, it is important that projection system development investigates and focuses on maximizing spectral bandwidth to an order of 1 pm, while simultaneously minimizing the deficiencies associated with the materials that are used, i.e., it is desirable to minimize the calcium fluoride blank mass.

It has long been realized that catadioptric reduction optical systems (i.e., ones that combine a reflective system with a refractive system) have several advantages, especially in a step and scan configuration, and that catadioptric systems are particularly well-suited to satisfy the aforementioned objectives. A number of parties have developed or proposed development of systems for wavelengths below 365 nm. One catadioptric system concept relates to a Dyson-type arrangement used in conjunction with a beam splitter to provide ray clearance and unfold the path to provide for parallel scanning (e.g., U.S. Pat. Nos. 5,537,260; 5,742,436; and 5,805,357). However, these systems have a serious drawback since the size of the beam-splitting element becomes quite large as the numerical aperture is increased, thereby making the procurement of optical material with sufficient quality (in three dimensions) to make the cube beam splitter a high risk endeavor, especially at a wavelength of 157 nm.

The difficulties associated with the cube beam splitter size are better managed by locating the cube beam splitter in the slot conjugate of the system, preferably near the reticle or at its 1× conjugate if the design permits. Without too much effort, this beam splitter location shrinks the linear dimension of the cube by up to 50%, depending upon several factors. The advantages of this type of beam splitter placement are described in U.S. Pat. No. 5,052,763 to Wilczynski. Further, U.S. Pat. No. 5,808,805 to Takahashi provides some different embodiments; however, the basic concept is the same as in Wilczynski.

It is also possible to remove the cube beam splitter entirely from the catadioptric system. In one approach, an off-axis design is provided using a group with a numerical aperture of 0.70 operating at 248 rum. In U.S. Pat. Nos. 6,195,213 and 6,362,926 to Omura et al. disclose other examples of this approach and U.S. Pat. No. 5,835,275 to Takahashi illustrates yet another example. Takahashi et al. offer several similar examples of beam splitter free designs in European patent application EP 1168028.

Most of these “cubeless” embodiments share a common theme, namely that the catadioptric group contains only a single mirror. Additional mirrors can possible be used to improve performance. However, designs with multiple mirrors have been investigated but have largely failed because these designs have proven unable to achieve adequately high numerical apertures (e.g., U.S. Pat. Nos. 4,685,777; 5,323,263; 5,515,207; and 5,815,310).

Another proposed solution is disclosed in U.S. Pat. No. 4,469,414 in which a restrictive off-axis field optical system is disclosed. The system disclosed in this reference does not include a doubly passed negative lens in a first partial objective. Further, the embodiments disclosed therein are of impractical geometry and of far too low numerical aperture to provide improved lithography performance in the ultraviolet wavelength region.

What has heretofore not been available is a catadioptric projection system that has particular utility in 157 nm lithography and produces an image with a numerical aperture of at least 0.80 and includes other desirable performance characteristics.

### SUMMARY

Various photolithographic reduction projection catadioptric objectives according to a number of embodiments are provided herein. An exemplary catadioptric projection system includes a first optical group and a second optical group that are both arranged so that the first optical group presents a reduced, virtual image to the second optical group. The first optical group is formed of three mirrors in combination with at least two lens elements and the second optical group is a substantially refractive optical group more image forward than the first optical group having a number of lenses. The second optical group provides image reduction. The first optical group provides compensative aberrative correction for the second optical group. The present objective forms an image with a numerical aperture of at least 0.80.

The objective is characterized by a design which is used off-axis in a ring field geometry so that no polarizing beam splitter cube is required. This eliminates problems associated with manufacture of the cube and also the provision of an illumination system that delivers polarized light to the cube. In other words, the design of the exemplary objective is such that the image field is off axis for the light beams to pass by mirrors and rectangular slits are often preferred over ring slits in practice. Thus, broadly speaking the present objective has a folded off-axis field geometry.

The present optical system achieves mask and wafer planes that are parallel to each other and perpendicular to the optical axis, enabling unlimited scanning in a step/scan lithographic configuration. While, the present embodiments have an axis of rotational symmetry, the system itself is not coaxial from the reticle to the wafer. Instead, the objective preferably utilizes a reflective field group in a folded, off-axis (ring) field geometry in a number of the present embodiments. By incorporating two separate folding mirrors, the system can path the beam in such away to enable this unlimited parallel scan.

According to a number of embodiments, the present optical system is designed to provide a system that can perform well in optical lithography applications where the wavelength is extended to 157 nm. Due to the arrangement of the optical groups, a system is provided that can operate at high numerical apertures (NA of 0.80 or more) for these particular microlithographic applications where a wavelength of 157 nm is desired.

The present catadioptric multi-mirror optical systems disclosed herein overcome the deficiencies associated with conventional catadioptric optical systems and offer a number of advantages, including the following: (1) a beam splitter is not required; (2) a polarized illuminator is likewise not required; (3) the systems do not require new technologies to be developed in order for the present systems to be implemented; and (4) low blank mass designs (<60 kg) are possible.

Other features and advantages of the present invention will be apparent from the following detailed description when read in conjunction with the accompanying drawings.

### BRIEF DESCRIPTION OF THE DRAWING FIGURES

The foregoing and other features of the present invention will be more readily apparent from the following detailed description and drawings figures of illustrative embodiments of the invention in which:

FIG. 1 schematically illustrates a microlithographic projection reduction objective according to a first embodiment, wherein the field groups are shown in a non-folded geometry;

FIG. 2 schematically illustrates the microlithographic projection reduction objective of FIG. 1 having one field group in a folded geometry;

FIG. 3 schematically illustrates a microlithographic projection reduction objective according to a second embodiment, wherein the field groups are shown in a non-folded geometry;

FIG. 4 schematically illustrates a microlithographic projection reduction objective according to FIG. 3 having one field group in a folded geometry; and

FIG. 5 schematically illustrates a microlithographic projection reduction objective according to a third embodiment having one field group in a folded geometry.

### DETAILED DESCRIPTION OF PREFERRED EMBODIMENTS

In order to provide the above advantages and to solve problems discussed above with respect to the related art systems, catadioptric projection systems according to a number of different embodiments are provided. The catadioptric projection system is formed of a two distinct imaging groups G1 and G2. Group G1 is a front end catadioptric group that provides a conjugate stop position to correct chromatic aberration, if desired, and works to balance the aberrations of the second group G2. This second group, G2, is dioptric and enables the system to achieve numerical apertures up to and in excess of 0.80. This catadioptric optical system achieves high numerical aperture preferably using no beam splitters and a non-coaxial geometry.

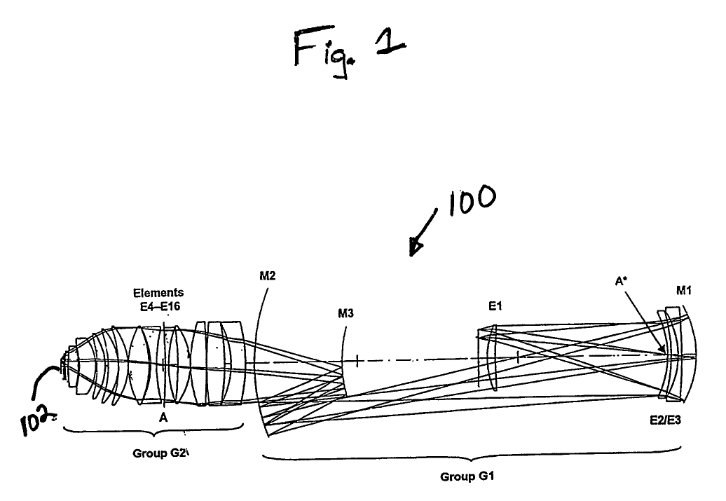

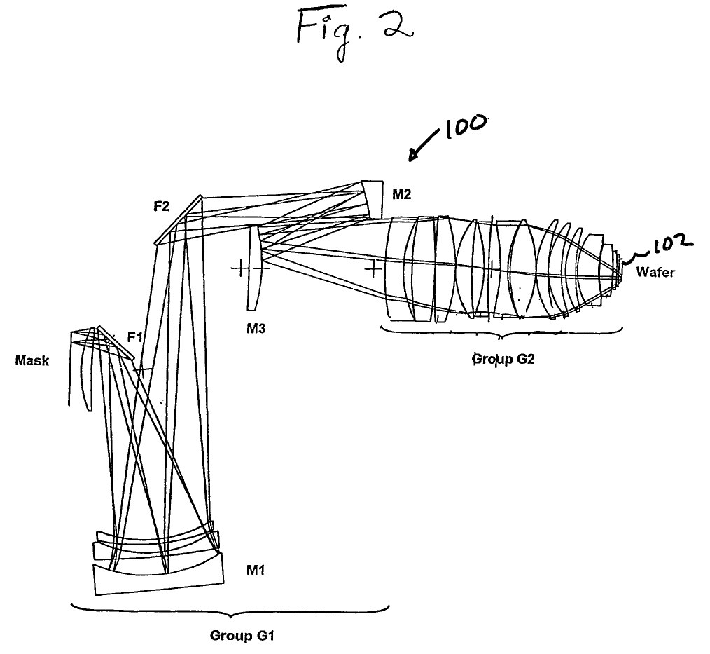

Referring first to FIGS. 1-2, a catadioptric multi-mirror (CMM) projection reduction objective 100 according to a first embodiment is illustrated. The specific details of this embodiment are set forth in Table 1, below. FIG. 1 is a schematic optical diagram of the system 100 illustrating the system 100 in an unfolded position to generally show the arrangement of the elements, while FIG. 2 is a schematic optical diagram of the system 100 after a pair of folding mirrors have been introduced into group G1. The system 100 is divided into two distinct functional groups: (1) group G1 including 3-mirrors and 3 lens elements and (2) group G2 including 13 individual lens elements and also preferably includes a protective plane parallel plate 102. In one embodiment, the protective plane parallel plate 102 is a CaFl plate with a 4 mm thickness.

Group G1 includes lens elements E1-E3 near the object plane and includes a concave mirror M2 and a convex mirror M3. The group G2 includes lens elements E4-E16, as shown, and as described in detail below with reference to FIGS. 1-2. The design according to the first embodiment has a non-coaxial geometry and does not include the use of beam splitter. While the exemplary embodiment has an axis of rotational symmetry, folds are required to enable unlimited parallel scanning. However, the designs of FIGS. 1 and 2 do not require a beam splitter since an off-axis ring field enables the necessary beam clearance to ensure that the mask and wafer planes are parallel. Group G1 forms a minified, virtual image located behind mirror M3 at a reduction of about ˜0.7x. Group G2 takes this virtual image and forms a usable real image at the image plane. G2 operates at reduction of about 0.29x, thereby allowing the system 100 to achieve a reduction of 0.25x.

One of the disadvantages of the system 100 in the arrangement shown in FIG. 1 is that unlimited parallel scanning is very difficult to obtain due to the positioning of the object plane (mask) relative to the group G2 and the wafer. More specifically, scanning equipment would be disposed between M3 and the mask and therefore is placed directly between groups G1 and G2. Such positioning would cause the scanner to interfere with the light that is traveling between M1 (Group G1) and M2 (Group G2) and therefore, this arrangement does not readily lend itself to unlimited parallel scanning.

The manner in which the embodiment of FIG. 1 achieves an unlimited parallel scanning scan is understood best by viewing the schematic optical diagram of FIG. 2. First, a first folding mirror F1 is added after the lens element E1 to deviate the image bundle by an included angle of 96°. The direction of the image bundle is then reversed by the reflection at concave mirror M1. A second folding mirror F2 is added to the beam path at a location that is between lens element E2 and concave mirror M2. This second folding mirror F2 acts to deviate the imaging bundles by an included angle of 84°. The second folding mirror F2 also serves to direct the imaging bundles in a direction that is parallel to the light emanating from the object plane. One will therefore appreciate that this arrangement permits the bundles impinging upon the mask (object plane) and the wafer in planes that are parallel to one another, thus enabling clearance at both the mask and wafer locations for unlimited parallel scanning.

To correct chromatic aberration, the aperture stop lies in group G2 has a conjugate position in G1 in close proximity to mirror M1, but not exactly at mirror M1. This allows a negative chief ray height at lens elements E2/E3 (for a positive field height at the reticle). This chief ray height, when combined with the sign of the marginal ray and the negative power of the E2/E3 pair, advantageously provides for a lateral chromatic aberration contribution that substantially cancels the lateral color contribution from group G2.

First, the strong negative power contained in elements E2 and E3 enable a strongly undercorrected or negative paraxial axial color (PAC) contribution that effectively balances the strongly overcorrected or positive PAC contribution from dioptric group G2. This correction mechanism is greatly enhanced by the double pass through these elements after reflection from mirror M1. For example, the transverse PAC contribution from G1 is −413.8 nm/pm, which balances the +423.5 nm/pm traverses PAC contribution from G2.

The large marginal ray height at second mirror M2 means that a small non-zero chief ray height (e.g., −8 mm to −12 mm) can be used to generate the overcorrected paraxial lateral color (PLC) contribution that is needed to balance the undercorrected PLC residual from the lens elements E4-E16 in group G2. Using this technique, an overcorrected PLC contribution of +36.8 nm/pm is generated in group G1, balanced against an undercorrected PLC contribution of −48.8 nm/pm from G2, netting a residual of +12 nm/pm. This corresponds to about 0.6 ppm if the lateral color is taken as a fraction of the maximum field height, and one of skill the art will appreciate that further improvements can be made to reduce this residual by making relatively small changes to this basic concept. One will further appreciate that independent PLC correction in both groups G1 and G2 can be employed without substantially altering this fundamental concept.

It is apparent that the intermediate image that is formed near the third mirror M3 is highly aberrated and the origin of this aberration is worthy of discussion. By design, the intermediate image is forced to suffer excessive coma and therefore, the rays from the periphery of the pupil focus below the chief ray at the intermediate image. Driving the lower rim ray from the conjugate stop away from the optical axis creates this coma, but in turn provides the necessary beam clearance at the second mirror M2. This large induced overcorrected contribution from group G1 is obviously balanced by group G2.

The monochromatic aberrations are corrected via a balance between groups G1 and G2. This is done in such a manner to as to leave the lens elements E4-E16 in the group G2 “unstressed”. The term “unstressed” is used to signify the fact that steep ray bendings are used sparingly with the group G2 to promote high-order aberration correction. Both the chief and marginal rays exhibit this behavior. The fact that this group is “unstressed” will be advantageous when manufacturing and assembly are considered in detail. A complete optical description is found in Table 1, describing the optical surfaces in Code V format. Table 2 summarizes the performance advantages of the first embodiment of FIG. 2.

TABLE 1
CMM4 (NA = 0.80, RED 4x, 26 mm × 6 mm)

| | | RDY | | THI | RMD | GLA | | |
|---|---|---|---|---|---|---|---|---|
| OBJ: | | INFINITY | | 25.000000 | | | | |
| 1: | | 250.00000 | | 22.810409 | | ‘CAF2HL’ | | |
| | ASP: | | | | | | | |
| | K: | −1.075429 | | | | | | |
| | A: | 0.125538E−07 | B: | 0.147868E−11 | C: | −.576890E−15 | D: | 0.857808E−19 |
| | E: | −.648763E−23 | F: | 0.210327E−27 | G: | 0.000000E+00 | H: | 0.000000E+00 |
| 2: | | 954.79639 | | 65.000000 | | | | |
| | ASP: | | | | | | | |
| | K: | −0.000000 | | | | | | |
| | A: | −.179142E−07 | B: | 0.109000E−11 | C: | −.315099E−15 | D: | 0.475542E−19 |
| | E: | −.377907E−23 | F: | 0.133703E−27 | G: | 0.000000E+00 | H: | 0.000000E+00 |
| 3: | | INFINITY | | 437.042974 | | | | |
| 4: | | −274.24783 | | 10.000000 | | ‘CAF2HL’ | | |
| 5: | | −449.76255 | | 19.973049 | | | | |
| 6: | | −244.00278 | | 10.000000 | | ‘CAF2HL’ | | |
| 7: | | −1670.83756 | | 41.343447 | | | | |
| 8: | | −295.67098 | | −41.343447 | REFL | | | |
| | ASP: | | | | | | | |
| | K: | 0.300479 | | | | | | |
| | A: | 0.126116E−09 | B: | −.372063E−14 | C: | −.196200E−18 | D: | 0.386274E−25 |
| | E: | −.144312E−27 | F: | 0.000000E+00 | G: | 0.000000E+00 | H: | 0.000000E+00 |
| 9: | | −1670.83756 | | −10.000000 | | ‘CAF2HL’ | | |
| 10: | | −244.00278 | | −19.973049 | | | | |
| 11: | | −449.76255 | | −10.000000 | | ‘CAF2HL’ | | |
| 12: | | −274.24783 | | −437.042974 | | | | |
| 13: | | INFINITY | | −466.741428 | | | | |
| 14: | | INFINITY | | −44.968432 | | | | |
| 15: | | 393.40984 | | −253.923787 | | | | |
| | ASP: | | | | | | | |
| | K: | 0.713474 | | | | | | |
| | A: | −.265652E−09 | B: | 0.548827E−13 | C: | 0.110844E−17 | D: | −.389360E−22 |
| | E: | 0.549220E−26 | F: | −.189776E−30 | G: | 0.000000E+00 | H: | 0.000000E+00 |
| 16: | | 608.12961 | | 253.923787 | REFL | | | |
| | ASP: | | | | | | | |
| | K: | 2.265746 | | | | | | |
| | A: | −.127008E−08 | B: | −.111402E−13 | C: | 0.117640E−18 | D: | −.427452E−23 |
| | E: | 0.531774E−28 | F: | −.339433E−33 | G: | 0.000000E+00 | H: | 0.000000E+00 |
| 17: | | 393.40984 | | −253.923787 | REFL | | | |
| | ASP: | | | | | | | |
| | K: | 0.713474 | | | | | | |
| | A: | −.265652E−09 | B: | 0.548827E−13 | C: | 0.110844E−17 | D: | −.389360E−22 |
| | E: | 0.549220E−26 | F: | −.189776E−30 | G: | 0.000000E+00 | H: | 0.000000E+00 |
| 18: | | 608.12961 | | −25.532658 | | | | |
| | ASP: | | | | | | | |
| | K: | 2.265746 | | | | | | |
| | A: | −.127008E−08 | B: | −.111402E−13 | C: | 0.117640E−18 | D: | −.427452E−23 |
| | E: | 0.531774E−28 | F: | −.339433E−33 | G: | 0.000000E+00 | H: | 0.000000E+00 |
| 19: | | −505.61165 | | −41.519274 | | ‘CAF2HL’ | | |
| 20: | | −250.00000 | | −18.831270 | | | | |
| | ASP: | | | | | | | |
| | K: | −0.003011 | | | | | | |
| | A: | 0.782960E−09 | B: | 0.148324E−13 | C: | −.150578E−17 | D: | −.713374E−22 |
| | E: | 0.110765E−26 | F: | −.112421E−30 | G: | 0.000000E+00 | H: | 0.000000E+00 |
| 21: | | −650.92301 | | −51.999527 | | ‘CAF2HL’ | | |
| 22: | | 1126.69736 | | −1.000000 | | | | |
| 23: | | −2010.62847 | | −45.992795 | | ‘CAF2HL’ | | |
| 24: | | 367.16775 | | −1.000000 | | | | |
| 25: | | −190.67651 | | −36.101411 | | ‘CAF2HL’ | | |
| 26: | | −798.36102 | | −27.285032 | | | | |
| 27: | | 323.59502 | | −10.000000 | | ‘CAF2HL’ | | |
| 28: | | −1827.68223 | | −4.115806 | | | | |
| STO: | | INFINITY | | −2.557789 | | | | |
| 30: | | INFINITY | | −19.272842 | | | | |
| 31: | | 430.42814 | | −17.000000 | | ‘CAF2HL’ | | |
| | ASP: | | | | | | | |
| | K: | −0.355544 | | | | | | |
| | A: | 0.163219E−08 | B: | −.950734E−13 | C: | 0.486342E−17 | D: | −.668270E−21 |
| | E: | 0.278808E−25 | F: | −.903556E−30 | G: | 0.000000E+00 | H: | 0.000000E+00 |
| 32: | | −234.28172 | | −5.079190 | | | | |
| 33: | | −273.31243 | | −59.552010 | | ‘CAF2HL’ | | |
| 34: | | 235.89653 | | −1.000000 | | | | |
| 35: | | −179.93654 | | −27.879988 | | ‘CAF2HL’ | | |
| 36: | | −322.21197 | | −1.000000 | | | | |
| 37: | | −159.06884 | | −29.579436 | | ‘CAF2HL’ | | |
| 38: | | −306.39329 | | −9.376632 | | | | |
| | ASP: | | | | | | | |
| | K: | 0.463329 | | | | | | |
| | A: | −.241823E−08 | B: | −.389512E−12 | C: | −.127203E−16 | D: | 0.314547E−21 |
| | E: | −.445940E−25 | F: | 0.113732E−30 | G: | 0.000000E+00 | H: | 0.000000E+00 |
| 39: | | −173.23883 | | −23.522507 | | ‘CAF2HL’ | | |
| 40: | | −351.33597 | | −3.886377 | | | | |
| | ASP: | | | | | | | |
| | K: | 6.080477 | | | | | | |
| | A: | 0.470221E−08 | B: | 0.811981E−12 | C: | 0.278385E−16 | D: | 0.896452E−21 |
| | E: | 0.594261E−26 | F: | 0.122574E−28 | G: | 0.000000E+00 | H: | 0.000000E+00 |
| 41: | | −146.14289 | | −47.074749 | | ‘CAF2HL’ | | |
| 42: | | −224.57708 | | −3.110892 | | | | |
| 43: | | −278.89465 | | −28.336921 | | ‘CAF2HL’ | | |
| 44: | | 675.11617 | | −1.434618 | | | | |
| 45: | | 544.27544 | | −7.000000 | | ‘CAF2HL’ | | |
| 46: | | 721.18670 | | −1.000000 | | | | |
| | ASP: | | | | | | | |
| | K: | 0.000000 | | | | | | |
| | A: | −.754975E−07 | B: | −.598923E−11 | C: | 0.354046E−14 | D: | −.198293E−17 |
| | E: | 0.413573E−21 | F: | −.686631E−25 | G: | 0.000000E+00 | H: | 0.000000E+00 |
| 47: | | INFINITY | | −4.000000 | | ‘CAF2HL’ | | |
| 48: | | INFINITY | | −8.000000 | | | | |
| IMG: | | INFINITY | | 0.000000 | | | | |

SPECIFICATION DATA

| | | | | | |
|---|---|---|---|---|---|
| NA | 0.80000 | | | | |
| DIM | MM | | | | |
| WL | 157.63 | 157.63 | 157.63 | | |
| REF | 2 | | | | |
| WTW | 0 | 1 | 0 | | |
| XOB | 0.00000 | 0.00000 | 0.00000 | 0.00000 | 0.00000 |
| YOB | 60.00000 | 66.00000 | 72.00000 | 78.00000 | 84.00000 |
| WTF | 1.00000 | 1.00000 | 1.00000 | 1.00000 | 1.00000 |
| VUX | −0.01246 | −0.01327 | −0.01417 | −0.01516 | −0.01625 |
| VLX | −0.01246 | −0.01327 | −0.01417 | −0.01516 | −0.01625 |
| VUY | 0.00000 | −0.00068 | −0.00173 | −0.00313 | −0.00503 |
| VLY | −0.03306 | −0.03558 | −0.03815 | −0.04071 | −0.04318 |

PRIVATE CATALOG

| PWL | ‘CAF2HL’ | ‘BAF2HL’ |
|---|---|---|
| 157.6400 | 1.559262 | 1.656663 |
| 157.6380 | 1.559267 | 1.656672 |
| 157.6360 | 1.559272 | 1.656680 |
| 157.6340 | 1.559277 | 1.656689 |
| 157.6320 | 1.559283 | 1.656698 |
| 157.6300 | 1.559288 | 1.656707 |
| 157.6280 | 1.559293 | 1.656715 |
| 157.6260 | 1.559298 | 1.656724 |
| 157.6240 | 1.559303 | 1.656733 |
| 157.6220 | 1.559309 | 1.656742 |
| 157.6200 | 1.559314 | 1.656750 |

FIRST ORDER PROPERTIES
INFINITE CONJUGATES

| | |
|---|---|
| EFL | 1093.8974 |
| BFL | 265.3223 |
| FFL | 4352.9846 |
| FNO | −0.5881 |

AT USED CONJUGATES

| | |
|---|---|
| RED | −0.2499 |
| FNO | −0.6250 |
| OBJ DIS | 25.0000 |
| TT | −1215.8650 |
| IMG DIS | −8.0000 |
| OAL | −1232.8650 |

PARAXIAL IMAGE

| | |
|---|---|
| HT | 20.9885 |
| THI | −8.0024 |
| ANG | 0.3156 |

ENTRANCE PUPIL

| | |
|---|---|
| DIA | 1859.9836 |
| THI | 4533.6085 |

EXIT PUPIL

| | |
|---|---|
| DIA | 11264.4627 |
| THI | 6890.2013 |

TABLE 2
Performance Summary of First Embodiment Illustrated in FIG. 2.

| Parameter | Performance |
|---|---|
| Configuration | Catadioptric multi-mirror |
| Wavelength (nm) | 157.6299 |
| Spectral band (pm) | 1.0 |
| Reduction ratio (R) | 4:1 |
| Numerical aperture (NA) | 0.80 |
| Field format | Ring |
| Field size (mm) | 26 mm × 6 mm |
| Total track (mm) | 1245.6 mm |
| Front working distance (mm) | 25.0 |
| Back working distance (mm) | 8.0 |
| Blank mass (kg) | 103.3 kg |
| Lens mass (kg) | 56.3 kg |
| Composite RMS wavefront | 0.0040 λ |
| error (waves) | |
| Distortion (nm) | <1.0 nm |
| CHL (nm/pm, paraxial) | 12 nm/pm |
| CHV (nm/pm, paraxial) | −12 nm/pm |

The system 100 has a composite RMS wavefront error of 4.0 mλ evaluated monochromatically over the field. The RMS wavefront error across the field ring varies from 3.2 mλ to 4.9 mλ, while the distortion is less than 1 nm at all field points. The paraxial color is corrected to 12 nm/pm, while the paraxial lateral color is corrected to better than 12 nm/pm. It will be appreciated that further correction means are available; however in the interest of brevity, these further means are not disclosed. The design of the first embodiment approaches the “zero aberration” condition required by state of the art lithographic scanners.

The aspheric decomposition of the system 100 is listed in Table 3. While it may be possible to make specific improvements to several of the different profiles, the aspheres are more than satisfactory for the design and intended application of system 100. Most of the surfaces have departures that are well below the 300 μm with both vertex and covering radii exceeding 300 mm. Moreover, the high-order asphere content is relatively low and displays favorable ratios between successive orders. Accordingly, the selection for good null lenses for the embodiment of FIG. 2 should be an easy task.

TABLE 3
Aspheric decomposition for the first embodiment of FIG. 2.

| | | R | Def | | | | | | |
|---|---|---|---|---|---|---|---|---|---|
| F1 | R vertex | envelope | (mu) | Z4 | Z9 | Z16 | Z25 | Z36 | Z49 |
| 1 | 250.00 | 247.74 | 17.1 | 10.8 | 0.75 | −12.24 | 4.00 | 1.24 | −0.050 |
| 2 | −954.80 | −1293.70 | 288.0 | 6.0 | 193.90 | −4.73 | −3.03 | −1.15 | −0.118 |
| 8 | −295.67 | −290.32 | 181.8 | 15.1 | −119.59 | −14.94 | −1.57 | −0.14 | −0.012 |
| 16 | −608.13 | −609.87 | 30.0 | −0.6 | 20.19 | 0.48 | −0.22 | 0.14 | −0.055 |
| 17 | 393.41 | 387.95 | 52.4 | −4.0 | 34.67 | 4.00 | 0.17 | 0.01 | 0.000 |
| 20 | −250.00 | −250.79 | 13.2 | 7.6 | 7.22 | −7.40 | −1.96 | −0.22 | −0.023 |
| 31 | −430.43 | −430.19 | 17.6 | −7.3 | 8.41 | 7.11 | 0.92 | 0.16 | 0.006 |
| 38 | −306.39 | −289.06 | 352.7 | 42.5 | −228.14 | −42.00 | −4.00 | −0.49 | −0.055 |
| 40 | −351.34 | −333.04 | 134.1 | −12.4 | −89.13 | 12.12 | 1.66 | 0.35 | 0.058 |
| 46 | 721.19 | 873.04 | 46.2 | 0.7 | −30.78 | −0.70 | −0.09 | −0.03 | 0.001 |

Where R vertex is the radius of the vertex of the surface, (i.e., at the optical axis R) and R envelope is the radius of the best fit sphere for the aspheric surface.

According to one exemplary configuration of the first embodiment, the group G2 contains more positive lens elements than negative lens elements and more specifically, the group G2 contains 4 negative lens elements and 9 positive lens elements. In this exemplary configuration, the lens element E16 (the most image forward lens element) is a negative lens and the lens element E4 (the least image forward lens element) is a negative lens and lens elements E5-E7 are positive lens elements; E8-E9 are negative lens elements; E10-E13 are positive lens elements; E14 is a negative lens element; and E15 is a positive lens element.

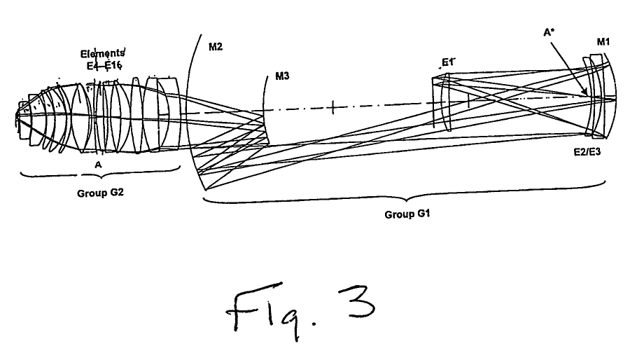

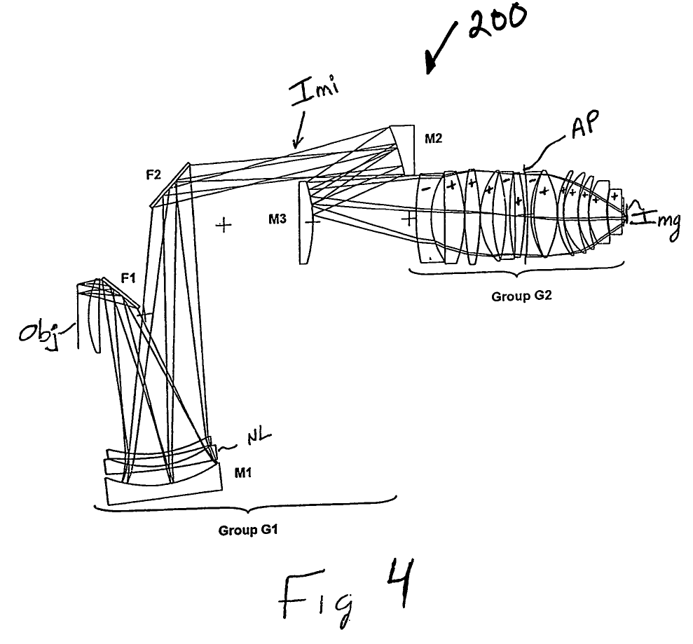

Now referring to FIGS. 3 and 4 in which a catadioptric multi-mirror (CMM) projection reduction objective 200 according to a second embodiment is illustrated. The system 200 is similar to the system 100 of FIGS. 1-2 and therefore like elements will be numbered alike. The system 200 is configured to provide a higher numeral aperture (e.g., up to and over 0.85) in comparison to the system 100. FIG. 3 is a schematic optical diagram of the system 200 illustrating the system 200 in a non-folded geometry to show the general configuration of the groups G1 and G2, while FIG. 4 is a schematic optical diagram of the system 200 after a pair of folding mirror have been introduced into group G1 to form a folded geometry. The system 200 is divided into two distinct functional groups: (1) group G1 including 3-mirrors and 3 lens elements and (2) group G2 including 13 individual lens elements and also preferably includes a protective plane parallel plate, e.g., a CaFl plate 102 with a 4 mm thickness. As with the first embodiment, the second embodiment, as exemplified in FIG. 3, illustrates that unlimited parallel scanning is difficult due to the position of the object (mask) between the groups G1 and G2 (thus potentially interfering with the light beams as they are directed from G1 to G2).

The system 200 achieves a numerical aperture of 0.85 over the same 26 mm×6 mm field at 4× reduction. The precise number of elements contained in the system 200 is the same as in the system 100, with the differences between the two systems being very subtle and found in the construction of the strong dioptric imaging group (i.e., group G2). More specifically, the lens elements E15 and E16 (of the first embodiment of FIGS. 1-2) were combined since the airspace in that particular region offered little high-order aberration correction. In addition, lens element E9 was thickened and then split to accommodate a measure of stop motion as a function of numerical aperture change. The real stop position was iterated and telecentricity was set as evident by the details of the prescription of the system 200 found in Table 4.

TABLE 4
CMM5 (NA = 0.85, RED 4x, 26 mm × 6 mm)

| | | RDY | | THI | RMD | GLA | | |
|---|---|---|---|---|---|---|---|---|
| OBJ: | | INFINITY | | 27.500000 | | | | |
| 1: | | 250.75754 | | 26.796951 | | ‘CAF2HL’ | | |
| | ASP: | | | | | | | |
| | K: | 0.643315 | | | | | | |
| | A: | 0.375238E−08 | B: | −.426719E−12 | C: | −.101968E−15 | D: | 0.139384E−19 |
| | E: | −.763099E−24 | F: | 0.158884E−28 | G: | 0.745968E−33 | H: | 0.000000E+00 |
| 2: | | 1117.72059 | | 65.000000 | | | | |
| | ASP: | | | | | | | |
| | K: | −0.000000 | | | | | | |
| | A: | −.245051E−07 | B: | 0.133567E−11 | C: | −.286713E−15 | D: | 0.371763E−19 |
| | E: | −.254131E−23 | F: | 0.838025E−28 | G: | 0.000000E+00 | H: | 0.000000E+00 |
| 3: | | INFINITY | | 414.363888 | | | | |
| 4: | | −313.31898 | | 10.000000 | | ‘CAF2HL’ | | |
| 5: | | −634.46160 | | 23.369190 | | | | |
| 6: | | −254.36878 | | 10.000000 | | ‘CAF2HL’ | | |
| 7: | | −1573.92355 | | 40.190663 | | | | |
| 8: | | −293.26597 | | −40.190663 | REFL | | | |
| | ASP: | | | | | | | |
| | K: | 0.306250 | | | | | | |
| | A: | 0.252354E−09 | B: | −.233221E−14 | C: | −.186781E−18 | D: | 0.420051E−23 |
| | E: | −.656907E−27 | F: | 0.371087E−31 | G: | −.886902E−36 | H: | 0.000000E+00 |
| 9: | | −1573.92355 | | −10.000000 | | ‘CAF2HL’ | | |
| 10: | | −254.36878 | | −23.369190 | | | | |
| 11: | | −634.46160 | | −10.000000 | | ‘CAF2HL’ | | |
| 12: | | −313.31898 | | −414.363888 | | | | |
| 13: | | INFINITY | | −456.753071 | | | | |
| 14: | | INFINITY | | −231.608485 | | | | |
| 15: | | 361.11422 | | −254.305252 | | | | |
| | ASP: | | | | | | | |
| | K: | 0.436451 | | | | | | |
| | A: | −.205371E−08 | B: | 0.378103E−13 | C: | −.784265E−19 | D: | 0.512401E−22 |
| | E: | −.190367E−26 | F: | −.333530E−31 | G: | 0.440089E−35 | H: | 0.000000E+00 |
| 16: | | 612.74229 | | 254.305252 | REFL | | | |
| | ASP: | | | | | | | |
| | K: | 1.496366 | | | | | | |
| | A: | −.920674E−09 | B: | −.410428E−14 | C: | −.147201E−19 | D: | −.151868E−24 |
| | E: | 0.385616E−30 | F: | −.619383E−35 | G: | −.235408E−40 | H: | 0.000000E+00 |
| 17: | | 361.11422 | | −254.305252 | REFL | | | |
| | ASP: | | | | | | | |
| | K: | 0.436451 | | | | | | |
| | A: | −.205371E−08 | B: | 0.378103E−13 | C: | −.784265E−19 | D: | 0.512401E−22 |
| | E: | −.190367E−26 | F: | −.333530E−31 | G: | 0.440089E−35 | H: | 0.000000E+00 |
| 18: | | 612.74229 | | −18.334494 | | | | |
| | ASP: | | | | | | | |
| | K: | 1.496366 | | | | | | |
| | IC: | YES | CUF: | 0.000000 | | | | |
| | A: | −.920674E−09 | B: | −.410428E−14 | C: | −.147201E−19 | D: | −.151868E−24 |
| | E: | 0.385616E−30 | F: | −.619383E−35 | G: | −.235408E−40 | H: | 0.000000E+00 |
| | J: | 0.000000E+00 | | | | | | |
| 19: | | −579.84933 | | −38.773026 | | ‘CAF2HL’ | | |
| 20: | | −209.35237 | | −34.897128 | | | | |
| | ASP: | | | | | | | |
| | K: | 0.177797 | | | | | | |
| | A: | −.879079E−09 | B: | 0.880296E−13 | C: | 0.142092E−17 | D: | −.666532E−22 |
| | E: | −.177138E−26 | F: | −.162845E−30 | G: | 0.000000E+00 | H: | 0.000000E+00 |
| 21: | | −35627.08209 | | −51.949197 | | ‘CAF2HL’ | | |
| 22: | | 354.63767 | | −1.000000 | | | | |
| 23: | | −658.49860 | | −39.153716 | | ‘CAF2HL’ | | |
| 24: | | 595.34695 | | −1.000000 | | | | |
| 25: | | −184.95622 | | −32.649278 | | ‘CAF2HL’ | | |
| 26: | | −388.54833 | | −33.913487 | | | | |
| 27: | | 426.70020 | | −10.200685 | | ‘CAF2HL’ | | |
| 28: | | −586.03919 | | −13.641244 | | | | |
| 29: | | 5000.31490 | | −24.250000 | | ‘CAF2HL’ | | |
| | ASP: | | | | | | | |
| | K: | 0.000000 | | | | | | |
| | A: | 0.217086E−08 | B: | 0.403980E−12 | C: | −.346062E−17 | D: | −.997397E−21 |
| | E: | 0.645400E−25 | F: | −.302950E−29 | G: | 0.627233E−34 | H: | 0.000000E+00 |
| 30: | | 514.43049 | | −1.471303 | | | | |
| | STO: | INFINITY | | −1.250000 | | | | |
| 32: | | INFINITY | | −5.346052 | | | | |
| 33: | | 1415.34740 | | −8.397572 | | ‘CAF2HL’ | | |
| 34: | | −217.61108 | | −8.434292 | | | | |
| 35: | | −280.65824 | | −59.297446 | | ‘CAF2HL’ | | |
| 36: | | 240.42032 | | −1.000000 | | | | |
| 37: | | −197.70579 | | −14.727989 | | ‘CAF2HL’ | | |
| 38: | | −231.78989 | | −1.000000 | | | | |
| 39: | | −136.05967 | | −36.800000 | | ‘CAF2HL’ | | |
| 40: | | −256.55558 | | −1.000000 | | | | |
| | ASP: | | | | | | | |
| | K: | −0.419386 | | | | | | |
| | A: | 0.308712E−09 | B: | 0.578238E−13 | C: | −.270761E−16 | D: | −.155239E−20 |
| | E: | 0.677684E−24 | F: | −.649913E−28 | G: | 0.223640E−32 | H: | 0.000000E+00 |
| 41: | | −156.42542 | | −26.817939 | | ‘CAF2HL’ | | |
| 42: | | −295.73385 | | −1.004028 | | | | |
| | ASP: | | | | | | | |
| | K: | 4.552794 | | | | | | |
| | A: | 0.314993E−07 | B: | 0.446978E−12 | C: | 0.834341E−16 | D: | −.484270E−20 |
| | E: | −.235342E−24 | F: | 0.996480E−28 | G: | −.403143E−32 | H: | 0.000000E+00 |
| 43: | | −150.97263 | | −46.000000 | | ‘CAF2HL’ | | |
| 44: | | −237.73524 | | −3.237596 | | | | |
| 45: | | −293.80346 | | −36.250000 | | ‘CAF2HL’ | | |
| 46: | | 2770.72546 | | −1.000000 | | | | |
| | ASP: | | | | | | | |
| | K: | 0.000000 | | | | | | |
| | A: | −.877599E−07 | B: | −.147771E−10 | C: | 0.140516E−14 | D: | −.390236E−17 |
| | E: | 0.374183E−20 | F: | −.212250E−23 | G: | 0.427890E−27 | H: | 0.000000E+00 |
| 47: | | INFINITY | | −4.000000 | | ‘CAF2HL’ | | |
| 48: | | INFINITY | | −8.002369 | | | | |
| IMG: | | INFINITY | | 0.000000 | | | | |

SPECIFICATION DATA

| | | | | | |
|---|---|---|---|---|---|
| NA | 0.85000 | | | | |
| DIM | MM | | | | |
| WL | 157.63 | 157.63 | 157.63 | | |
| REF | 2 | | | | |
| WTW | 0 | 1 | 0 | | |
| XOB | 0.00000 | 0.00000 | 0.00000 | 0.00000 | 0.00000 |
| YOB | 60.00000 | 66.00000 | 72.00000 | 78.00000 | 84.00000 |
| WTF | 1.00000 | 1.00000 | 1.00000 | 1.00000 | 1.00000 |
| VUX | 0.00427 | 0.00337 | 0.00237 | 0.00126 | 0.00003 |
| VLX | 0.00427 | 0.00337 | 0.00237 | 0.00126 | 0.00003 |
| VUY | 0.00038 | −0.00198 | −0.00473 | −0.00793 | −0.01152 |
| VLY | −0.00165 | −0.00310 | −0.00465 | −0.00633 | −0.00806 |

| | | | | | | | | |
|---|---|---|---|---|---|---|---|---|
| CRA | W2 | F1 | Z1 | Target point (S31): | X: | 0.00000 | Y: | 4.53482 |
| CRA | W2 | F2 | Z1 | Target point (S31): | X: | 0.00000 | Y: | 4.96290 |
| CRA | W2 | F3 | Z1 | Target point (S31): | X: | 0.00000 | Y: | 5.38625 |
| CRA | W2 | F4 | Z1 | Target point (S31): | X: | 0.00000 | Y: | 5.80152 |
| CRA | W2 | F5 | Z1 | Target point (S31): | X: | 0.00000 | Y: | 6.21229 |

PRIVATE CATALOG

| PWL | ‘CAF2HL’ | ‘BAF2HL’ |
|---|---|---|
| 157.6400 | 1.559262 | 1.656663 |
| 157.6380 | 1.559267 | 1.656672 |
| 157.6360 | 1.559272 | 1.656680 |
| 157.6340 | 1.559277 | 1.656689 |
| 157.6320 | 1.559283 | 1.656698 |
| 157.6300 | 1.559288 | 1.656707 |
| 157.6280 | 1.559293 | 1.656715 |
| 157.6260 | 1.559298 | 1.656724 |
| 157.6240 | 1.559303 | 1.656733 |
| 157.6220 | 1.559309 | 1.656742 |
| 157.6200 | 1.559314 | 1.656750 |

FIRST ORDER PROPERTIES
INFINITE CONJUGATES

| | |
|---|---|
| EFL | 860.1411 |
| BFL | 206.9926 |
| FFL | 3413.7090 |
| FNO | −0.2257 |

AT USED CONJUGATES

| | |
|---|---|
| RED | −0.2500 |
| FNO | −0.5882 |
| OBJ DIS | 27.5000 |
| TT | −1388.1687 |
| IMG DIS | −8.0024 |
| OAL | −1407.6663 |

PARAXIAL IMAGE

| | |
|---|---|
| HT | 20.9961 |
| THI | −8.0024 |
| ANG | 0.4364 |

ENTRANCE PUPIL

| | |
|---|---|
| DIA | 3810.2848 |
| THI | 8734.8350 |

EXIT PUPIL

| | |
|---|---|
| DIA | 615.9190 |
| THI | 346.0314 |

Similar to the first embodiment, the second embodiment in the folded geometry of FIG. 4 utilizes a first folding mirror F1 and a second folding mirror F2. The first folding mirror F1 is added after the lens element E1 to deviate the image bundle. The direction of the image bundle is then reversed at concave mirror M1. A second folding mirror F2 is added to the beam path between lens element E2 and concave mirror M2. This second folding mirror F2 also acts to deviate the imaging bundles and direct them in a direction that is parallel to the light emanating from the object plane. The first and second folding mirrors F1 and F2 work together to ensure that the line of sight is displaced but not deviated.

According to one exemplary configuration of the second embodiment, the group G2 contains more positive lens elements than negative lens elements and more specifically, the group G2 contains 3 negative lens elements and 10 positive lens elements. In this exemplary configuration, the lens element E16 (the most image forward lens element) is a positive lens and the lens element E4 (the least image forward lens element) is a negative lens and lens elements E5-E7 are positive lens elements; E8 is a negative lens elements; E9 is a positive lens element; E10 is a negative lens element; E11-E16 are positive lens elements.

While the fundamentals of the aberration correction remain the same, several incremental improvements were made as the numerical aperture was scaled. The front working distance was increased from 25 mm to 27.5 mm and it will be appreciated that a larger front working distance is possible with additional design modifications. The composite wavelength error is 3.6 mλ which is an improvement over the design of the first embodiment set forth in FIGS. 1 and 2. The RMS wavefront error is also better balanced across the field ring, ranging from 2.5 mλ to 4.1 mλ. The centroid distortion is reduced to less than 3 mn. Tables 5 and 6 provide an overview of the design of the second embodiment. These tables therefore reflect the additional modifications that were done in order to bring the design of FIGS. 3 and 4 to a higher state of correction. At the 4 mλ level with good distortion correction, the design of system 200 processes excellent CD control at 65 nm with an acceptable k₁-factor.

TABLE 5
Performance Summary of Second Embodiment Illustrated in FIG. 4.

| Parameter | Performance |
|---|---|
| Configuration | Catadioptric multi-mirror |
| Wavelength (nm) | 157.6299 |
| Numerical aperture (NA) | 0.85 |
| Field format | Ring |
| Field size (wafer) (mm) | 26 mm × 6 mm |
| Reduction ratio (nominal) | 4:1 |
| Total track length (mm) | 1245.6 mm |
| Blank mass | 110.16 kg |
| Maximum diameter | 273.3 mm |
| Front working distance (mm) | 27.5 |
| Back working distance (mm) | 8.0 |
| Telecentricity error | 7.6 mrad (mask) |
| | −0.4 mrad (wafer) |
| Composite RMS wavefront | 0.0036 λ |
| error (waves) | |
| Chief ray distortion (nm) | <1.0 nm |
| Axial chromatic aberration (CHL) | 12 nm/pm |
| Lateral chromatic aberration (CVL) | 11 nm/pm |

TABLE 6
RMS wavefront error and centroid shift across field of view for the
second embodiment of FIG. 4.

| | | | Shift | | | |
|---|---|---|---|---|---|---|
| | | | (x, y, in | Focus | RMS | |
| | Field Fract | DEG | nm) | (mm) | (waves) | Strehl |
| Y | 0.71 | −0.27 | 0.000000 | 0.000000 | 0.0033 | 1.000 |
| Y | 0.79 | −0.16 | 0.000001 | 0.000000 | 0.0035 | 1.000 |
| Y | 0.86 | 0.00 | 0.000000 | 0.000000 | 0.0025 | 1.000 |
| Y | 0.93 | 0.20 | 0.000003 | 0.000000 | 0.0040 | 0.999 |
| Y | 1.00 | 0.44 | 0.000000 | 0.000000 | 0.0041 | 0.999 |

The asphere decomposition of the system 200 is illustrated in Table 7. Generally, the design of system 200 uses relatively mild aspheres and is tailored in such a way so that the deepest departures lie on surfaces with the strongest radii. The design of system 200 sits atop a broad plateau of local minimum which indicates that slight modifications can be made to produce improvements in terms of both reduced asphere count and reduced element count. For example, the aspheric departure on A17 was driven to 8.5 μm and it is likely that this asphere can be eliminated with some additional modifications.

TABLE 7
Aspheric decomposition for the second embodiment of FIG. 4.

| | | R | Def | | | | | | |
|---|---|---|---|---|---|---|---|---|---|
| F1 | R vertex | envelope | (mu) | Z4 | Z9 | Z16 | Z25 | Z36 | Z49 |
| 1 | 250.76 | 246.40 | 43.9 | 8.6 | 23.39 | −9.89 | 5.41 | 1.21 | 0.098 |
| 2 | −1117.72 | −1877.04 | 375.0 | 15.6 | 251.56 | −13.92 | −4.15 | −1.53 | −0.039 |
| 8 | −293.27 | −288.03 | 187.2 | 16.3 | −122.86 | −16.04 | −1.73 | −0.21 | −0.045 |
| 16 | −612.74 | −618.20 | 127.6 | −3.2 | 85.05 | 3.38 | 0.11 | 0.04 | 0.007 |
| 17 | 361.11 | 361.84 | 8.5 | −5.5 | 2.77 | 5.45 | 0.24 | 0.02 | 0.005 |
| 20 | −209.35 | −206.56 | 103.9 | 4.0 | −68.08 | −3.46 | −2.49 | −0.49 | −0.052 |
| 29 | −5000.31 | −2993.27 | 247.7 | 10.4 | −166.65 | −10.56 | 4.69 | 0.21 | −0.014 |
| 40 | −256.56 | −259.73 | 45.8 | 6.5 | 28.96 | −7.23 | 0.64 | 0.61 | 0.095 |
| 42 | −295.73 | −305.51 | 90.6 | 9.2 | 59.81 | −9.17 | −0.30 | 0.26 | 0.080 |
| 46 | 2770.73 | 42538.56 | 71.1 | 3.4 | −47.14 | −3.38 | −0.28 | −0.05 | −0.003 |

The first and second embodiments of FIGS. 1-4 were constructed to illustrate and prove that improved lithographic performance can be realized by such designs. Once lithographic performance is realized, it is also desirable to optimize the blank mass of the system and more specifically, blank mass reduction is desirable to product a system that has specifications that support use in a number of microlithographic applications. Since it well known that the blank mass scales with the volume, a logical method of reducing the blank mass is by scaling. The track length is simply scaled down by a factor that gives the target blank mass and reoptimization is used to cover the performance of the system (e.g., unfolding the system 200 of FIG. 4 in a straight line would yield a system that is about 2625 mm in length).

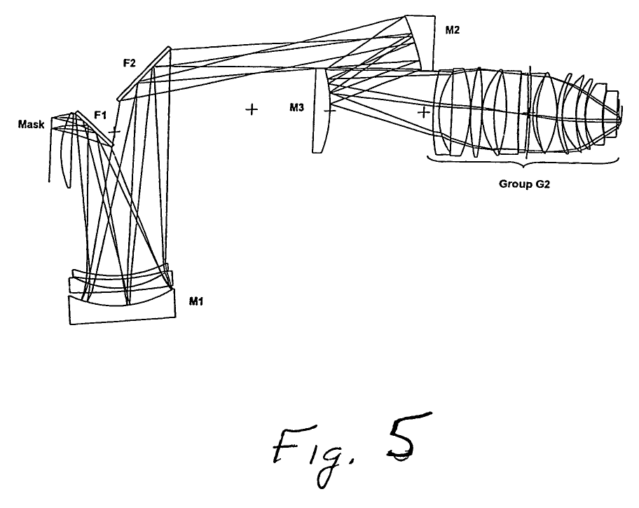

In one exemplary embodiment, the system 200 of FIGS. 34 was scaled by a factor of 0.80 (i.e., a reduction in scale by 20%) and this resulted in the blank mass being effectively reduced from 110.2 kg to 56.5 kg. This exemplary scaled system is illustrated in FIG. 5 which shows the fold geometry of this embodiment illustrating a total track from mask to wafer of 1250 mm and an axis offset of 100 mm. Because this embodiment is merely a scaled version of the second embodiment of FIG. 4, the two field groups, namely groups G1 and G2, of this embodiment have the same general arrangement. More specifically, a folded off-axis field geometry is presented and includes folding mirrors F1 and F2 which deviate the image bundles and also direct the image bundles in a direction that is parallel to the light emanating from the object plane.

One disadvantage of using scaling for blank mass reduction is that all constructional parameters scale down with the selected scale factor, including the forward working distance, back working distance, ray clearances, etc. Thus, the scaling of a system is not always indicative of success since many systems have arrangements of elements that do not lend themselves to scaling since one or more of the conventional parameters are significantly changed by the scaling to a degree that the system no longer provides satisfactory performance. Advantageously, the present system has an arrangement of elements that permits scaling without reducing the overall performance of the system.

Table 8 sets forth the performance summary for the embodiment of FIG. 5. where the system has been scaled for blank mass reduction. The reoptimized design recovers performance to the 4-5 mλ level with reductions in both blank mass and lens diameter. A complete optical prescription of this embodiment is found in Table 9, describing the optical surfaces in Code V format. What the prescription reveals is that the inner radius of the ring field is to 12 mm in this scaled embodiment, meaning that a 22 mm wide ring field is more appropriate. This would eliminate excessive over scan and problems associated with non-compensable induced distortions.

TABLE 8
Performance Summary of Third Embodiment Illustrated in FIG. 5.

| Parameter | Performance |
|---|---|
| Configuration | Catadioptric multi-mirror |
| Wavelength (nm) | 157.6299 |
| Numerical aperture (NA) | 0.85 |
| Field format | Ring |
| Field size (wafer) (mm) | 26 mm × 6 mm |
| Reduction ratio (nominal) | 4:1 |
| Total track length (mm) | 1249.4 mm |
| Blank mass | 56.54 kg |
| Maximum diameter | 219.05 mm |
| Front working distance (mm) | 24.0 |
| Back working distance (mm) | 6.5 |
| Telecentricity error | 11.0 mrad (mask) |
| | −0.3 mrad (wafer) |
| Composite RMS wavefront | 0.0046 λ |
| error (waves) | |
| Chief ray distortion (nm) | <1.0 nm |
| Axial chromatic aberration (CHL) | 11 nm/pm |
| Lateral chromatic aberration (CVL) | 6 nm/pm |

TABLE 9
CMH5B (NA = 0.85, RED 4x, 22 mm × 6 mm)

| | | RDY | | THI | RMD | GLA | | |
|---|---|---|---|---|---|---|---|---|
| OBJ: | | INFINITY | | 24.000000 | | | | |
| 1: | | 207.00939 | | 22.333546 | | ‘CAF2HL’ | | |
| | ASP: | | | | | | | |
| | K: | 0.568678 | | | | | | |
| | A: | 0.729757E−08 | B: | −.218318E−11 | C: | −.159774E−15 | D: | 0.576072E−19 |
| | E: | −.731859E−23 | F: | 0.462094E−27 | G: | −.643482E−32 | H: | 0.000000E+00 |
| 2: | | 1213.71090 | | 52.000000 | | | | |
| | ASP: | | | | | | | |
| | K: | −0.000000 | | | | | | |
| | A: | −.441531E−07 | B: | 0.132862E−11 | C: | −.456838E−15 | D: | 0.925296E−19 |
| | E: | −.949943E−23 | F: | 0.459158E−27 | G: | 0.000000E+00 | H: | 0.000000E+00 |
| 3: | | INFINITY | | 322.999758 | | | | |
| 4: | | −260.97346 | | 8.000000 | | ‘CAF2HL’ | | |
| 5: | | −439.25617 | | 19.826927 | | | | |
| 6: | | −185.79402 | | 8.000000 | | ‘CAE2HL’ | | |
| 7: | | −1243.42554 | | 32.040021 | | | | |
| 8: | | −232.79919 | | −32.040021 | REFL | | | |
| | ASP: | | | | | | | |
| | K: | 0.302136 | | | | | | |
| | A: | 0.626210E−09 | B: | −.841820E−14 | C: | −.947279E−18 | D: | 0.870461E−22 |
| | E: | −.155617E−25 | F: | 0.132316E−29 | G: | −.469008E−34 | H: | 0.000000E+00 |
| 9: | | −1243.42554 | | −8.000000 | | ‘CAF2HL’ | | |
| 10: | | −185.79402 | | −19.826927 | | | | |
| 11: | | −439.25617 | | −8.000000 | | ‘CAF2HL’ | | |
| 12: | | −260.97346 | | −322.999758 | | | | |
| 13: | | INFINITY | | −359.384296 | | | | |
| 14: | | INFINITY | | −170.683294 | | | | |
| 15: | | 299.09023 | | −203.444201 | | | | |
| | ASP: | | | | | | | |
| | K: | 0.514840 | | | | | | |
| | A: | −.382918E−08 | B: | 0.725933E−13 | C: | 0.654351E−17 | D: | −.145697E−20 |
| | E: | 0.232996E−24 | F: | −.197345E−28 | G: | 0.712719E−33 | H: | 0.000000E+00 |
| 16: | | 490.19383 | | 203.444201 | REFL | | | |
| | ASP: | | | | | | | |
| | K: | 1.586527 | | | | | | |
| | IC: | YES | CUF: | 0.000000 | | | | |
| | A: | −.185561E−08 | B: | −.152714E−13 | C: | 0.132922E−19 | D: | −.419160E−23 |
| | E: | 0.584718E−28 | F: | −.662059E−33 | G: | 0.122186E−38 | H: | 0.000000E+00 |
| 17: | | 299.09023 | | −203.444201 | REFL | | | |
| | ASP: | | | | | | | |
| | K: | 0.514840 | | | | | | |
| | A: | −.382918E−08 | B: | 0.725933E−13 | C: | 0.654351E−17 | D: | −.145697E−20 |
| | E: | 0.232996E−24 | F: | −.197345E−28 | G: | 0.712719E−33 | H: | 0.000000E+00 |
| 18: | | 490.19383 | | −19.438335 | | | | |
| | ASP: | | | | | | | |
| | K: | 1.566527 | | | | | | |
| | A: | −.185561E−08 | B: | −.152714E−13 | C: | 0.132922E−19 | D: | −.419160E−23 |
| | E: | 0.584718E−28 | F: | −.662059E−33 | G: | 0.122186E−38 | H: | 0.000000E+00 |
| 19: | | −500.49259 | | −12.158880 | | ‘CAF2HL’ | | |
| 20: | | −165.34718 | | −27.329093 | | | | |
| | ASP: | | | | | | | |
| | K: | 0.203521 | | | | | | |
| | A: | 0.526494E−08 | B: | 0.257453E−12 | C: | −.721759E−18 | D: | −.111168E−20 |
| | E: | 0.290607E−25 | F: | −.715423E−29 | G: | 0.000000E+00 | H: | 0.000000E+00 |
| 21: | | −10313.35337 | | −40.583842 | | ‘CAF2HL’ | | |
| 22: | | 284.00292 | | −1.000157 | | | | |
| 23: | | −423.15993 | | −24.145832 | | ‘CAF2HL’ | | |
| 24: | | 748.01179 | | −1.000000 | | | | |
| 25: | | −146.66790 | | −25.774514 | | ‘CAF2HL’ | | |
| 26: | | −305.95658 | | −27.233674 | | | | |
| 27: | | 332.08485 | | −25.433416 | | ‘CAF2HL’ | | |
| 28: | | −1477.82233 | | −1.459014 | | | | |
| 29: | | −1446.53285 | | −18.000000 | | ‘CAF2HL’ | | |
| | ASP: | | | | | | | |
| | K: | 0.000000 | | | | | | |
| | A: | 0.384416E−08 | B: | 0.154668E−11 | C: | −.631358E−16 | D: | −.628240E−20 |
| | E: | 0.812023E−24 | F: | −.720999E−28 | G: | 0.292765E−32 | H: | 0.000000E+00 |
| 30: | | 1484.39533 | | −1.513822 | | | | |
| STO: | | INFINITY | | −1.000000 | | | | |
| 32: | | INFINITY | | −2.551519 | | | | |
| 33: | | 2267.19035 | | −5.600000 | | ‘CAF2HL’ | | |
| 34: | | −160.45420 | | −8.414921 | | | | |
| 35: | | −223.12245 | | −44.360251 | | ‘CAF2HL’ | | |
| 36: | | 196.18301 | | −1.000000 | | | | |
| 37: | | −186.36511 | | −10.994942 | | ‘CAF2HL’ | | |
| 38: | | −225.52208 | | −1.000000 | | | | |
| 39: | | −106.90196 | | −29.440000 | | ‘CAF2HL’ | | |
| 40: | | −212.58159 | | −1.000000 | | | | |
| | ASP: | | | | | | | |
| | K: | −1.041760 | | | | | | |
| | A: | 0.115266E−07 | B: | 0.281979E−12 | C: | −.318861E−16 | D: | −.100655E−19 |
| | E: | 0.112326E−22 | F: | −.168580E−26 | G: | 0.819985E−31 | H: | 0.000000E+00 |
| 41: | | −121.50990 | | −19.769986 | | ‘CAF2HL’ | | |
| 42: | | −206.83912 | | −1.000011 | | | | |
| | ASP: | | | | | | | |
| | K: | 4.169043 | | | | | | |
| | A: | 0.542363E−07 | B: | 0.460754E−11 | C: | 0.315548E−15 | D: | −.246620E−19 |
| | E: | −.117861E−22 | F: | 0.322114E−26 | G: | −.669762E−31 | H: | 0.000000E+00 |
| 43: | | −114.81661 | | −36.800000 | | ‘CAF2HL’ | | |
| 44: | | −224.38877 | | −2.080128 | | | | |
| 45: | | −262.19698 | | −29.000000 | | ‘CAF2HL’ | | |
| 46: | | 2343.39495 | | −1.000000 | | | | |
| | ASP: | | | | | | | |
| | K: | 0.000000 | | | | | | |
| | A: | −.182479E−06 | B: | −.498942E−10 | C: | 0.151521E−13 | D: | −.440447E−16 |
| | E: | 0.514209E−19 | F: | −.386081E−22 | G: | 0.103412E−25 | H: | 0.000000E+00 |
| 47: | | INFINITY | | −3.200000 | | ‘CAF2HL’ | | |
| 48: | | INFINITY | | −6.500000 | | | | |
| IMG: | | INFINITY | | 0.000000 | | | | |

SPECIFICATION DATA

| | | | | | |
|---|---|---|---|---|---|
| NA | 0.85000 | | | | |
| DIM | MM | | | | |
| WL | 157.63 | 157.63 | 157.63 | | |
| REF | 2 | | | | |
| WTW | 0 | 1 | 0 | | |
| XOB | 0.00000 | 0.00000 | 0.00000 | 0.00000 | 0.00000 |
| YOB | 48.00000 | 54.00000 | 60.00000 | 66.00000 | 72.00000 |
| WTF | 1.00000 | 1.00000 | 1.00000 | 1.00000 | 1.00000 |
| VUX | 0.00369 | 0.00254 | 0.00122 | −0.00028 | −0.00198 |
| VLX | 0.00369 | 0.00254 | 0.00122 | −0.00028 | −0.00198 |
| VUY | −0.00024 | −0.00330 | −0.00698 | −0.01133 | −0.01566 |
| VLY | −0.00227 | −0.00416 | −0.00620 | −0.00838 | −0.00998 |

| | | | | | | | | |
|---|---|---|---|---|---|---|---|---|
| CRA | W2 | F1 | Z1 | Target point (S31): | X: | 0.00000 | Y: | 3.60687 |
| CRA | W2 | F2 | Z1 | Target point (S31): | X: | 0.00000 | Y: | 4.03238 |
| CRA | W2 | F3 | Z1 | Target point (S31): | X: | 0.00000 | Y: | 4.45040 |
| CRA | W2 | F4 | Z1 | Target point (S31): | X: | 0.00000 | Y: | 4.85831 |
| CRA | W2 | F5 | Z1 | Target point (S31): | X: | 0.00000 | Y: | 5.28916 |

PRIVATE CATALOG

| PWL | ‘CAF2HL’ | ‘BAF2HL’ |
|---|---|---|
| 157.6400 | 1.559262 | 1.656663 |
| 157.6380 | 1.559267 | 1.656672 |
| 157.6360 | 1.559272 | 1.656680 |
| 157.6340 | 1.559277 | 1.656689 |
| 157.6320 | 1.559283 | 1.656698 |
| 157.6300 | 1.559288 | 1.656707 |
| 157.6280 | 1.559293 | 1.656715 |
| 157.6260 | 1.559298 | 1.656724 |
| 157.6240 | 1.559303 | 1.656733 |
| 157.6220 | 1.559309 | 1.656742 |
| 157.6200 | 1.559314 | 1.656750 |

FIRST ORDER PROPERTIES
INFINITE CONJUGATES

| | |
|---|---|
| EFL | 655.5733 |
| BFL | 157.3257 |
| FFL | 2599.3567 |
| FNO | −0.2325 |

AT USED CONJUGATES

| | |
|---|---|
| RED | −0.2499 |
| FNO | −0.5882 |
| OBJ DIS | 24.0000 |
| TT | −1064.9605 |
| IMG DIS | −6.5000 |
| OAL | −1082.4605 |

PARAXIAL IMAGE

| | |
|---|---|
| HT | 17.9927 |
| THI | −6.5012 |
| ANG | 0.6167 |

ENTRANCE PUPIL

| | |
|---|---|
| DIA | 2819.2031 |
| THI | 6460.6721 |

EXIT PUPIL

| | |
|---|---|
| DIA | 478.6437 |
| THI | 268.6287 |

The below Table 10 illustrates that the aspheric surface set for this embodiment.

TABLE 10
Aspheric decomposition for the third embodiment of FIG. 5.

| | | R | Def | | | | | | |
|---|---|---|---|---|---|---|---|---|---|
| F1 | R vertex | envelope | (mu) | Z4 | Z9 | Z16 | Z25 | Z36 | Z49 |
| 1 | 207.01 | 205.13 | 23.7 | 14.5 | −12.74 | −15.12 | 4.30 | 0.57 | 0.123 |
| 2 | −1213.71 | −3535.66 | 431.3 | 10.1 | 289.45 | −9.15 | −3.10 | −0.89 | −0.104 |
| 8 | −232.80 | −228.77 | 147.4 | 13.2 | −96.64 | −12.96 | −1.41 | −0.22 | −0.057 |
| 16 | −490.19 | −494.48 | 110.6 | −3.1 | 73.96 | 3.50 | 0.17 | 0.12 | −0.002 |
| 17 | 299.09 | 299.52 | 8.9 | −4.7 | 3.73 | 4.64 | 0.22 | 0.03 | 0.010 |
| 20 | −165.35 | −164.77 | 45.8 | 12.8 | −25.09 | −12.19 | −3.46 | −0.55 | −0.065 |
| 29 | 1446.53 | 1867.89 | 172.6 | 4.3 | −116.73 | −4.28 | 4.22 | 0.03 | −0.022 |
| 40 | −212.58 | −230.99 | 366.2 | −27.4 | 240.59 | 27.28 | 5.16 | 0.02 | −0.096 |
| 42 | −206.84 | −202.04 | 134.1 | 30.4 | −78.11 | −28.72 | −5.52 | 0.54 | 0.307 |
| 46 | 2343.39 | −10272.02 | 80.8 | 5.0 | −53.38 | −4.85 | −0.62 | −0.11 | −0.009 |

The optical design description provided herein demonstrates an advantageous catadioptric projection system for DUV or VUV lithography. While the present embodiments have been designed for use in a 157 nm tool (scanner), the basic concept has no wavelength limitations, either shorter or longer, providing a suitable refractive material exists for the particular application that is desired.

In summary, the various optical systems disclosed herein are each characterized as being a catadioptric optical system consisting of two groups, G1 and G2, constructed so that group G1 presents a reduced virtual image to group G2. The function of group G2 is to relay this virtual image to a real image located at the plane of the wafer. Group G1 is constructed of 3 mirrors in combination with at least two lens elements whose primary function is to provide telecentricity at the mask and enable correction of axial chromatic aberration In the embodiments disclosed herein, an image of the aperture stop is located in close proximity to mirror M1.

Group G2 is preferably entirely dioptric providing most of the system and a corresponding high numerical aperture (up to or in excess of 0.75) at the wafer. This group G2 also makes the final image telecentric in wafer space. Group G1 aids correction of high-order field aberrations and the Petzval sum, allowing a substantial relaxation of the lens elements found in group G2. Both groups G1 and G2 make use of at least 8 aspheric surfaces as listed in Tables 3, 7 and 9.

The present system utilizes a reflective field group in a folded off-axis field geometry. Because the system is used off-axis in an off-axis field geometry, no beam splitter cube is required and therefore, the present system is free from the complications associated with the use of a beam splitter cube (most notably, the manufacture of the beam splitter cube itself and the design of an illumination system that delivers polarized light to the beam splitting cube). As a result, the present system does not require the polarization at the reticle to be polarized.

The disclosed embodiments make use of a coma at the intermediate image to ensure proper ray clearance in the M2/M3 mirror region of the design. This coma is added to the design to help minimize the obliquity of the off-axis field.

The optical system achieves mask and wafer planes that are parallel to each other and perpendicular to the optical axis, enabling unlimited scanning in step/scan lithographic configuration.

While the present embodiments have an axis of rotational symmetry, the system itself is not coaxial from the reticle to the mask. The configuration of the present system relies on the use of two separate folding mirrors to path the beam in such away to enable the aforementioned unlimited parallel scan. FIGS. 2, 4, and 5 illustrate the present embodiments where a folded mirror configuration is used.

Correction of chromatic aberration is achieved using a single optical material in this catadioptric configuration. The lateral chromatic aberration is substantially balanced between group G1 and G2 using a favorable balance of power near the conjugate stop location in close proximity to mirror M1. Correction of axial chromatic aberration is enabled using a negative lens group located at mirror M1 in group G1, providing an axial chromatic aberration contribution that is nearly equal in magnitude and opposite in sign to the chromatic aberration generated by group G2. This high level of axial chromatic aberration correction eliminates the need for a high spectral purity laser and therefore, enables a spectral bandwidth in excess of 1 pm.

The exemplary embodiments disclosed herein include the first embodiment which has a 26 mm×6 mm field operating at a numerical aperture of 0.80; a second embodiment, is disclosed having a numerical aperture of 0.85. The design of the second embodiment illustrates that by making several modifications the numerical aperture can be expanded to 0.85 using the same off-axis (ring) field geometry with essentially the same blank mass as in the first embodiment. The third embodiment discloses an optical system that is also operated at a numerical aperture of 0.85 but has been redesigned in such a way as to use only ½ of the lens material as either the first and second embodiments.

In another aspect of the present optical systems, as shown in FIG. 4, an objective is provided and includes a first partial objective with a concave mirror (M1) and at least one negative lens (NL) that is double passed by light traveling to and from the concave mirror (M1); an intermediate image (Imi); and a second partial objective with two curved mirrors (M2, M3) and a plurality of lenses (G2). The intermediate image (Imi) is thus located between the first and second partial objectives.

The second partial objective has two curved mirrors (M2, M3) that are configured and arranged to form a virtual image. The lens group (G2) is provided imageward of the two curved mirrors (M2, M3) and is configured so that it provides reduction magnification.

The optical system includes a system aperture (AP) that is located within the second partial objective and only a purely refractive lens group is arranged between the system aperture (AP) and an image plane (IMG). According to the exemplary embodiment shown in FIG. 4, the system aperture (AP) is located between lens (E9) and lens (E10). In this embodiment, the refractive lens group that is arranged between the system aperture (AP) and the image plane (IMG) contains one negative lens (E10) and six positive lenses (E11-E16).

According to one exemplary embodiment, the first partial objective is a catadioptric group providing the intermediate image (Imi) and the second partial objective is an optical group selected from the group of optical groups consisting of a catoptric group and a catadioptric group, for providing the virtual image. The plurality of lenses (G2) is a dioptric group providing the real image. According to one embodiment, the plurality of lenses (G2) includes a positive lens group of more than 5 tenses (E11-E16) and a least image forward lens of the purely refractive group comprises a negative lens (E10).

It will be appreciated that an objective can be constructed having any number of combinations of any of the aforementioned features. Thus, it will be appreciated that an objective can be constructed having any number of combinations of claimed features.

While exemplary drawings and specific embodiments of the present invention have been described and illustrated, it is to be understood that the scope of the present invention is not to be limited to the particular embodiments discussed. Thus, the embodiments shall be regarded as illustrative rather than restrictive, and it should be understood that variations may be made in those embodiments by workers skilled in the art without departing from the scope of the present invention as set forth in the claims that follow, and equivalents thereof. In addition, the features of the different claims set forth below may be combined in various ways in further accordance with the present invention.

1. A microlithographic reduction projection catadioptric objective (100, 200) comprising in sequence from an object side to an image side of:
a catadioptric group (G1) for providing a virtual image, wherein the catadioptric group (G1) comprises a reflective field group and includes a folded off-axis field geometry; and
a dioptric group (G2) for receiving the virtual image and providing a real image.

2. A microlithographic reduction projection catadioptric objective (100, 200) comprising:
a catadioptric group (G1) including a reflective field group for providing a virtual image, wherein the reflective field group is arranged in a folded off-axis field geometry to fold light such that object and image planes are parallel to one another and perpendicular to an optical axis to enable unlimited scanning in a step/scan lithographic configuration; and
a dioptric group (G2) for receiving the virtual image and providing a real image.

3. An objective (100, 200) as in claim 2, wherein the catadioptric group (G1) includes at least three lens elements (E1-E3).

4. An objective (100, 200) as in claim 2, wherein the catadioptric group (G1) includes three mirrors (M1-M3) and two flat folding mirrors (F1, F2).

5. An objective (100, 200) according to claim 4, wherein two mirrors (M2, M3) are positioned downstream of the two flat folding mirrors (F1, F2).

6. An objective (100, 200) according to claim 5, wherein the two mirrors (M2, M3) downstream of the two flat folding mirrors (F1, F2) comprise a concave mirror and a convex mirror, respectively.

7. An objective (100, 200) according to claim 6, wherein the convex mirror (M3) is the most image forward mirror.

8. An objective (100, 200) according to claim 4, wherein one of the folding mirrors (F2) is upstream of the most image forward lens element (E2) of the catadiotric group (G1).

9. An objective (100, 200) according to claim 4, wherein the most image forward folding mirror (F2) is disposed between a second lens element (E2) and a second mirror (M2), the most image forward folding mirror (F2) deviating a beam and directing it in a direction that is parallel to a beam emanating from the object plane.

10. (canceled)

11. An objective as in claim 2, wherein the real image is formed with a numerical aperture of at least substantially 0.85.

12. An objective according to claim 2, wherein the catadioptric group (G1) includes a most image forward convex mirror (M3) that receives a beam after it has been twice folded and wherein the dioptric group (G2) receives a beam from the convex most image forward convex mirror (M3).

13. An objective (100, 200) according to claim 4, wherein one folding mirror (F2) and two of the mirrors (M2, M3) are upstream of the most image forward lens element (E2) of the catadioptric group (G1).

14. An objective (100, 200) according to claim 13, wherein the two mirrors (M2, M3) are more image forward than the both folding mirrors (F1, F2), where one of the two mirrors (M2) receives the folded beam from a second folding mirror (F2) and reflects the beam to the other of the two mirrors (M3) which represents the most image forward mirror of the catadioptric group (G1).

15. An objective (100, 200) according to claim 2, wherein the catadioptric group (G1) includes a single-pass lens element (E1) and first and second folding mirrors (F1, F2) that are arranged so that a beam incident to the single-pass lens element (E1) and exiting the dioptric group (G2) propagate along substantially parallel axes.

16. An objective (100, 200) as in claim 2, wherein a least image forward lens element (E4) of the dioptric group (G2) is a negative lens and a most image forward lens element (E16) of the dioptric group (G2) is a positive lens.

17. An objective (100, 200) according to claim 4, wherein second and third mirrors (M2, M3) are arranged upstream of the two folding mirrors (F1, F2) and each of the three lens elements (E1-E3), the second mirror (M2) being a concave mirror that receives the folded beam from a most image forward folding mirror (F2) and reflects the beam to the third convex mirror (M3) which reflects light to the dioptric group (G2).

18. An objective (100, 200) according to claim 2, wherein the catadioptric group (G1) includes two folding mirrors (F1, F2) and a reflective group (M2, M3) upstream of a most image forward folding mirror (F2), the reflective group (M2, M3) including one concave mirror and one convex mirror.

19. An objective (100, 200) according to claim 18, further including a negative lens group (E2, E3) disposed between the two folding mirrors (F1, F2).

20. An objective (100, 200) according to claim 2, wherein the dioptric group (G2) includes more positive lens elements than negative lens elements.

21. An objective (100, 200) according to claim 2, wherein the dioptric group (G2) includes a number of lens elements (E4-E16) and has a negative overall magnifying power for providing image reduction.

22. A photolithographic reduction projection catadioptric objective (100, 200), comprising:
a first optical group (G1) includes an odd number of mirrors (M1-M3); and
a second substantially refractive optical group (G2) more image forward than the first optical group (G1), the second optical group (G2) including a number of lens elements (E4-E16) and having a negative overall magnifying power for providing image reduction;
wherein the first optical group (G1) has a folded geometry for producing a virtual image and the second optical group (G2) receives and reduces the virtual image to form an image with a numerical aperture of at least substantially 0.80, wherein a beam exiting the second optical group (G2) is parallel to and displaced from a beam incident to a first lens element (E1) of the first optical group (G1).

23. An objective (100, 200) according to claim 22, wherein the first optical group (G1) comprises a catadioptric group having a single pass lens (E1) and a double-pass lens group (E2, E3).

24. An objective (100, 200) as in claim 22, wherein the first optical group (G1) includes at least three mirrors (M1-M3) arranged such that a second mirror (M2) having a concave surface faces a convex surface of a third mirror (M3) such that the second mirror (M2) receives a beam that has been folded within the first optical group (G1) and reflects the beam to the convex surface of the third mirror (M3).

25. An objective (100, 200) according to claim 24, wherein light is folded within the first optical group (G1) by first and second folding mirrors (F1, F2) that are arranged so that a beam exiting the first optical group (G1) and a beam incident to a first lens element (E1) of the first optical group (G1) propagate along substantially parallel axes.

26. An objective (100, 200) according to claim 22, wherein the second dioptric group (G2) includes more positive lens elements than negative lens elements.

27. An objective (100, 200) according to claim 22, wherein the first and second optical groups (G1, G2) include at least eight aspheric surfaces.

28. An objective (100, 200) according to claim 22, wherein the first optical group (G1) includes at least three mirrors (M1-M3) and two folding mirrors (F1, F2) with two of the three mirrors (M2, M3) being located along the optical path more image forward than the two folding mirrors (F1, F2) such that one of the two mirrors (M2) receives a folded beam from the folding mirror (F2) that is more image forward and reflects the beam to the other of the two mirrors (M3) which represents the most image forward mirror of the catadioptric group (G1).

29. An objective (100, 200) according to claim 22, wherein the first optical group (G1) includes a single pass lens (E1) and a double-pass lens group (E2, E3), the double-pass lens group (E2, E3) being disposed between first and second folding mirrors (F1, F2).

30. A photolithographic reduction projection catadioptric objective (100, 200), comprising:
a first optical group (G1) includes an odd number of mirrors (M1-M3); and
a second substantially refractive optical group (G2) more image forward than the first optical group (G1), the second optical group (G2) including a number of lenses (E4-E16) and having a negative overall magnifying power for providing image reduction;
wherein the first optical group (G1) has a folded off-axis field geometry and provides compensative aberrative correction for the second optical group (G2) which forms an image with a numerical aperture of at least substantially 0.80.

31. A photolithographic reduction projection catadioptric objective (100, 200) devoid of a beam splitter device, the objective comprising:
a first optical group (G1) including an odd number of at least three mirrors (M1-M3) including a convex most image forward mirror (M3); and
a second substantially refractive optical group (G2) more image forward than the first optical group (G1) for receiving a beam from the convex most image forward mirror (M3) of the first group (G1) after the beam has been folded along an optical path of the first optical group (G1), wherein the second optical group (G2) includes a number of lens elements (E4-E16) for providing image reduction.

32. An objective (100, 200) according to claim 31, wherein the first optical group (G1) comprises a catadioptric group having at a positive lens (E1) and a negative lens group (E2, E3) arranged such that the beam incident to a first lens element (E1) is folded twice prior to the beam being received by a reflective image forward mirror group (M2, M3) including the convex most image forward mirror (M3).

33. (canceled)

34. An objective (100, 200) according to claim 31, wherein the objective has a blank mass of less than 57 kg at a 22 mm×6 mm field operating at a numerical aperture of at least substantially 0.85.

35.-36. (canceled)

37. A microlithographic reduction projection objective (100, 200), comprising:
a first partial objective with a concave mirror (M1) and at least one negative lens (NL) doubly passed by light traveling to and from the concave mirror (M1);
an intermediate image (Imi); and
a second partial objective with two curved mirrors (M2, M3) and a plurality of lenses (G2).

38.-41. (canceled)
